(19) United States
(12) Patent Application Publication
(10) Pub. No.: US 2014/0211451 A1
(43) Pub. Date: Jul. 31, 2014

(54) Display Device, Backlight Module, and Field Emission Light Source Built Therein

(71) Applicant: Yewen Wang, Shenzhen City (CN)

(72) Inventor: Yewen Wang, Shenzhen City (CN)

(73) Assignee: Shenzhen China Star Optoelectronics Technology Co. Ltd., Shenzhen, Guangdong (CN)

(21) Appl. No.: 13/820,149

(22) PCT Filed: Feb. 1, 2013
(86) PCT No.: PCT/CN13/71268

§ 371 Date: Mar. 1, 2013

(30) Foreign Application Priority Data
Jan. 30, 2013 (CN) 201310036129.3

(51) Int. Cl. F21V 33/00

(52) U.S. Cl. CPC F21V 33/00
USPC 362/97.1

(57) ABSTRACT

The present invention discloses a display device, a backlight module, and a first emitting light source. The light emitting light source includes first and second substrates arranged relatively with each other. A first electrode layer is formed on an internal side of the first substrate; and a second electrode layer is formed on an internal side of the second substrate. An light-emitting layer is arranged between the first and second transparent conductive layers, and formed over the first transparent conductive layer, wherein the light-emitting layer includes a quantum dot material. And wherein the second transparent conductive layer is used to emit electrons toward the light emitting layer so as to create illumination for being used in is backlight module. A quantum dot material is incorporated so as to increase the light emitting performance of the light emitting light source.

### FIELD OF THE INVENTION

The present invention relates to a technical field of display, and more particularly to a field emission on light source for use with the display. The present invention further relates to a backlight module incorporated with the field emission light source, and a display device built with such a backlight module.

### BACKGROUND OF THE INVENTION

Even since the introduction of the liquid crystal display device with its featured quality of clear, compact, low energy consumption, and prolonged service life, it has become the mainstream of the display device.

Normally, the liquid crystal display device needs a backlight module to illuminate the liquid crystal display such that the image display thereon can been clearly seen. In the past, the cold cathode fluorescent lamp (CCFL) and the light emitting diode (LED) have been selected as the light source of the backlight module. The CCFL features a light source as it has a light tube, while the LED is a spot or point light from its configuration. Accordingly, both of the backlight modules need a waveguide, a reflector, a diffuser and others so as to evenly distribute the light across the overall display. It works, but with a comparably high manufacturing cost.

Currently, a field emission light source has been introduced and built into a backlight module so as to illuminate the display. The existing field emission light source creates a light source by directing an electrical beam bombing toward a fluorescent powder. However, the oxides, nitrides, and silicates are poor in their conductivity when they are used as fluorescent powder. On the other hand, when the quantity of the fluorescent powder used increases, electrons can be readily accumulated or built up and eventually negatively reduce the voltages. Once the voltage is lowered, the light emitting property is also dragged down. In other world, because of the instability of the fluorescent powder, the display relying on the light emitting from the fluorescent powder of the field emitting light source also become instable. As a result, it fails to meet the requirements of the display industry.

### SUMMARY OF THE INVENTION

It is an object of the present invention to provide a display device, a backlight module and a field emitting light source incorporated within the backlight module and the display device so as to improve the performance of the field emitting light source and which in turn improve the performance of the display device incorporated with such a field emitting light source.

In order to resolve the prior art issue, the present invention introduces a technical solution by providing a field emitting light source for use with a backlight module includes first and second substrates arranged relatively with each other and made from glass substrate. A first electrode layer is formed on art internal side of the first substrate and which is a first transparent conductive layer on which a light emitting layer is deployed thereon by means of printing or sputtering. A second electrode layer is formed on an internal side of the second substrate and which includes a second transparent conductive layer and an electrically charged electron emitter formed on the second transparent conductive layer, wherein the electrically charged electron emitter includes nanotubes made from carbon or zinc oxide. An light-emitting, layer is arranged between the first and second transparent conductive layers, and formed over the first transparent conductive layer, wherein the light-emitting layer includes a quantum dot material. And wherein the second transparent conductive layer is used to emit electrons toward the light emitting layer so as to create illumination for being used in a backlight module.

Wherein the electrically charged electron emitter is deployed over the second conductive layer by means of printing or sputtering.

Wherein the field emitting light source further includes two contained isolation layers arranged between the first and second substrates such that a vacuumed space is created between the first and second substrates, wherein the light emitting layer and the electrically charged electron emitter are arranged within the vacuumed space completely or in partial.

Wherein the material used to form the contained isolation layers includes glass powder with low melting, point.

In order to resolve the prior art issue, the present invention introduces a technical solution by providing a light emitting light source which includes first and second substrates arranged relatively with each other. A first electrode layer is formed on an internal side of the first substrate; and a second electrode layer is formed on an internal side of the second substrate. An light-emitting layer is arranged between the first and second transparent conductive layers, and formed over the first transparent conductive layer, wherein the light-emitting layer includes a quantum dot material. And wherein the second transparent conductive layer is used to emit electrons toward the light emitting layer so as to create illumination for being used in a backlight module.

Wherein the first electrode layer is a first transparent conductive layer on which a light emitting layer is deployed thereon by means of printing or sputtering.

Wherein the first electrode layer includes a second transparent conductive layer and an electrically charged electron emitter formed on the second transparent conductive layer formed on the second substrate, wherein the electrically charged electron emitter includes nanotubes made from carbon or zinc oxide.

Wherein the electrically charged electron emitter is deployed over the second conductive layer by means of printing or sputtering.

Wherein the field emitting light source further includes two contained isolation layers arranged between the first and second substrates such that a vacuumed space is created between the first and second substrates, wherein the light emitting layer and the electrically charged electron emitter are arranged within the vacuumed space completely or in partial.

Wherein the material used to form the contained isolation layers includes glass powder with low melting point.

In order to resolve the prior art issue, the present invention introduces a technical solution by providing a display device which includes a light emitting light source configured with first and second substrates arranged relatively with each other. A first electrode layer is formed on an internal side of the first substrate; and a second electrode layer is formed on an internal side of the second substrate. An light-emitting layer is arranged between the first and second transparent conductive layers, and formed over the first transparent conductive layer, wherein the light-emitting layer includes a quantum dot material. And wherein the second transparent conductive layer is used to emit electrons toward the light emitting layer so as to create illumination for being used in a backlight module.

Wherein the first electrode layer is a first transparent conductive layer on which a light emitting layer is deployed thereon by means of printing or sputtering.

Wherein the first electrode layer includes a second transparent conductive layer and an electrically charged electron emitter formed on the second transparent conductive layer formed on the second substrate, wherein the electrically charged electron emitter includes nanotubes made from carbon or zinc oxide.

Wherein the electrically charged electron emitter is deployed over the second conductive layer by means of printing or sputtering.

Wherein the field emitting light source further includes two contained isolation layers arranged between the first and second substrates such that a vacuumed space is created between the first and second substrates, wherein the light emitting layer and the electrically charged electron emitter are arranged within the vacuumed space completely or in partial.

Wherein the material used to form the contained isolation layers includes glass powder with low melting point.

The present invention can be concluded with the following advantages. As compared to the existing technology, since the quantum dot material has been incorporated into the field emitting light source as a light emitting material, the excellent conductivity of the quantum dot material can readily improve the light emitting capacity as well as broadened colors as compared to the conventional fluorescent powder. In addition, with the time lapses, the accumulated charges or electrons can be effectively discharged or drained out, and the light emitting capacity of high performance can be maintained. In addition, with the application of the field emitting light source, the waveguide, reflector and diffuser can be omitted thereby effectively reduce the manufacturing cost of the backlight module and the display device.

### BRIEF DESCRIPTION OF DRAWINGS

FIG. 1 is an illustrational and configuration view of a field emitting light source made in accordance with the present invention;

FIG. 2 is a cross sectional view of the field emitting light source taken along line A-A′ of FIG. 1;

FIG. 3 discloses backlight nodule incorporated with a plurality of field emitting light source disclosed in FIGS. 1; and

FIG. 4 is a flow chart diagram illustrating the steps in making the field emitting light source made in accordance with the present invention.

### DETAILED DESCRIPTION OF PREFERRED EMBODIMENTS

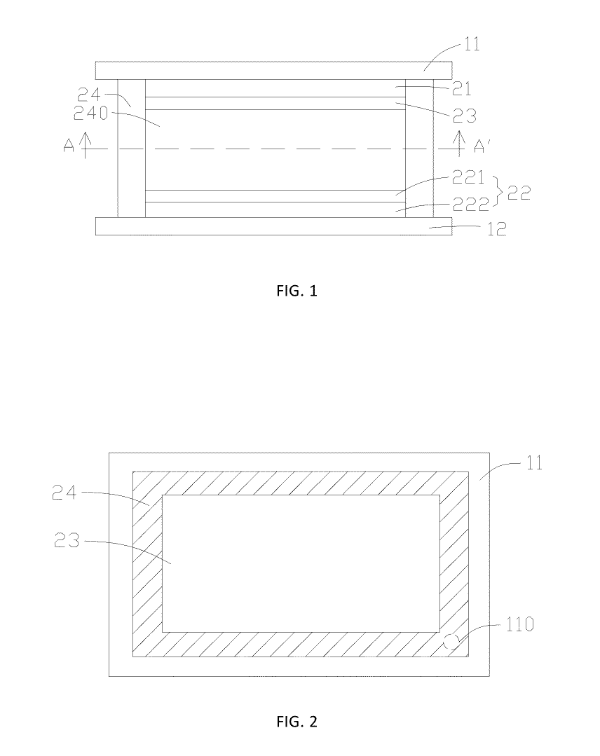

Referring to FIGS. 1 and 2, wherein FIG. 1 is an illustrational and configuration view of a field emitting light source made in accordance with the present invention; and FIG. 2 is a cross sectional view of the field emitting light source taken along line A-A′ of FIG. 1.

In the actual embodiment, the field emitting light source can be incorporated within a backlight module or other equipment in which a light source is needed. No limitations should be imposed herewith.

The field emitting light source includes, but not limited thereto, a first substrate 11, a second substrate 12, a second electrode layer 22, a light emitting layer 23, and a contained isolation layer 24.

The first substrate 11 can be made from ordinary glass, a clear glass, or as super clear glass or any other harder and transparent material. In the current embodiment, a comparably cost-effective clear glass is used which satisfies requirements of lower absorption and high penetration rate (more than 90%). Of course, in other embodiment, a super clear glass can also be utilized. This super clear glass can be utilized into a high end field emitting light source. In addition, the thickness of the first substrate 11 ranges 5˜15 micrometer. It can be readily appreciated that the thickness can be readily adjusted according to the requirements of the field emitting light source. No limitation will be imposed herewith.

The second substrate 12 and the first substrate 11 are arranged in face-to-face manner. In the present invention, the internal surfaces or the facing surfaces of the first and second substrates 11, 12 are defined as internal side, and it should be noted that the first and second substrates 11, 12 are arranged in parallel. It should be noted that the first and second substrates 11 and 12 could be arranged with a predetermined angle. For example, if a reflector is incorporated within the field emitting light source, then a predetermined angle will be set between the first and second substrates 11, 12 as long as a back light source can be defined. Similarly, the second substrate 12 can be made from ordinary glass, a clear glass or a super clear glass or any other harder and transparent material. In the current embodiment, a comparably cost-effective clear glass is used which satisfies requirements of lower absorption and high penetration rate (more than 90%). Of course, in other embodiment, a super clear glass can also be utilized. This super clear glass can be utilized into a high-end field emitting light source. In addition, the thickness of the first substrate 11 ranges 5˜15 micrometer. it can be readily appreciated that the thickness can be readily adjusted and increased according to the requirements of the field emitting light source. In the current embodiment, the light can be projected from one side of the first substrate 11 so as to provide the illumination to the liquid crystal display device. Alternatively, the light eau be projected from a side from the second substrate 12 with a reflector incorporated thereof. No limitations should he imposed herewith.

It should he noted that a diffusing arrangement could be created on the external surfaces of the first and second substrates 11, 12 so as to improve the homogeneousness of the projected light beam emitted therefrom. The substantial configuration can be readily determined according to field requirements, and it can be readily appreciated by the skill in the art. No detailed description will be given herewith.

The first electrode layer 2 is formed on the internal side of the first substrate 11, i.e. the surface facing the second substrate 12. Substantially, the first electrode layer 21 can be formed by PVD, i.e. Physical vapor deposition and which is a transparent conductive layer. The first transparent conductive layer can be a layer of indium tin oxide (IDO). Of course, in order to facilitate electricity connection, certain conductive traces (not shown in Figures) have to be arranged and no detailed will be given.

The second electrode layer 22 is formed on the internal surface of the second substrate 12. The second electrode layer 22 includes a second transparent conductive layer 222 and an electrically charged electron emitter 221 disposed above the second substrate 222. The electrically charged electron emitter 221 can be made from nanotubes of carbon or zinc oxide or alternatively, a composition of carbon and zinc oxide nanotubes mixed with a certain ratio. During the manufacturing process, the electrically charged electron emitter 221 can be deployed over the second transparent conductive layer 222 by means of adhesive, printing or sputtering.

In other alternative embodiments, the electrically charged electron emitter 221 can be included with other metallic particulates, such as indium tin oxide or indium silver oxide, low melting point glass, and other organic carrier, such as the terpineol, dibutyl phthalate and ethyl cellulose. Its substantial composition can be readily determined according to the field requirements. For example, 5˜15% of carbon nanotube (or zinc oxide nanotube), 10˜20% of metallic conductive particulates, 5% of low melting glass, and 60˜80% of organic carrier. By means of this arrangement, the electrically charged electron emitter 221 can be evenly deployed over the second transparent conductive layer 222, and a homogeneous light can be achieved.

A light emitting layer 23 and the second substrate 22 are arranged in juxtapose, i.e. the light emitting layer 23 is arranged between the first and second substrates 11, 12, and formed on the first substrate 11. Substantially, the light-emitting layer 23 can be arranged over the first substrate 21 by means of printing or sputtering. In the currently embodiment, the light emitting layer 23 includes quantum dots which has excellent conductivity according to the current embodiment, and it can effectively increase the performance of the field emitting light source. On the other hand, the quantum dot has narrowed peak, and with the application of the quantum dots, the light-emitting layer 23 can achieve a broadened colors. On the other hand, with the eclipse of the time, the accumulated electrons can be readily drained or discharged, and the performance of the field emitting light source can be maintained.

Substantially, with the adjustment and arrangement of the red, green, blue, and yellow quantum dot, a comparably abundant spectrum of different power distribution can be achieved. Later, with the application of a color filter of the display device, a high-end display certified by NTSC and Adobe can be achieved.

As shown in FIG. 2, during the manufacturing, a packaging process will be conducted. An orifice will be formed in the first and second substrates 11, 12, and with this orifice 110, a vacuum can be created. An isolation layer 24 is arranged between the first and second substrates 11, 12 such that a vacuumed space 240 is created between the first and second substrates 11, 12. Afterward, the orifice 110 is sealed to keep the vacuum. The isolation layer 24 can be arranged in rim shape. Of course, it can be embodied with circular rim, triangular rim or other irregular shape. No limitation will be imposed herewith. Substantially, the light-emitting layer 23 can be disposed within the vacuumed space 240 completely or in partial. The electrically charged electron emitter 221 can be also arranged within the vacuumed space 240 completely or in partial. It should be noted that, the isolation layer 24 is made from glass of low melting point with high intensity, such as metal or ceramic. The isolation layer 24 can also serve as a supporter or spacer between the first and second substrates 11, 12. Accordingly, as long as the first and second substrates 11, 12 can be readily spaced and supported, metal and ceramic can be used to configure the isolation layer.

During the operation, the first and second electrode layers 21, 22 are electrified, and than the second electrode layer 22 will emit electrically charged electrons bombing the light emitting layer 23 to create the light. As such, a light source is created for use with a backlight module.

According to the present invention, since the quantum dot material has been incorporated into the field emitting light source as a light-emitting layer 23, the excellent conductivity of the quantum dot material can readily improve the light emitting capacity as well as broadened colors as compared to the conventional fluorescent powder. In addition, with the time lapses, the accumulated charges or electrons can be effectively discharged or drained out, and the light emitting capacity of high performance can be maintained. In addition, with the application of the field emitting light source, the waveguide, reflector and diffuser can be omitted thereby effectively reduce the manufacturing cost of the backlight module and the display device.

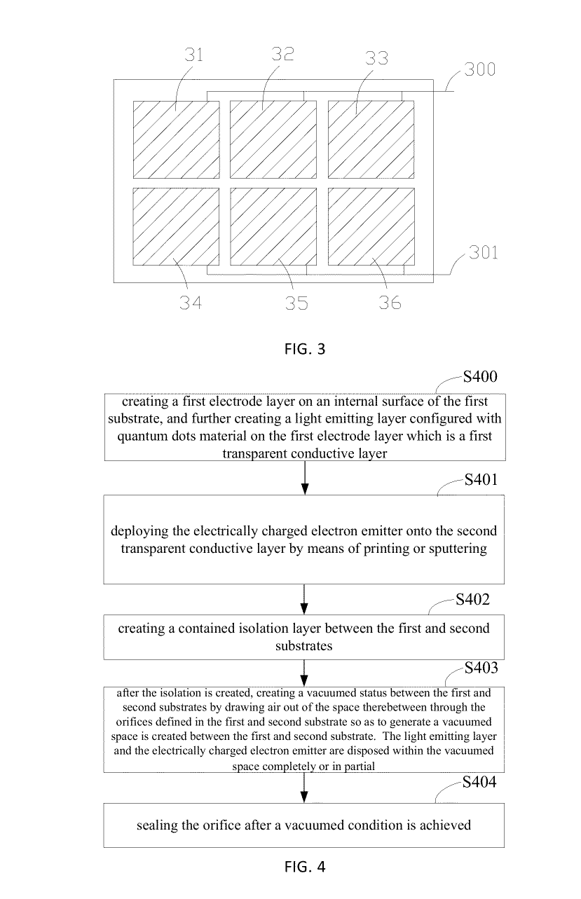

Referring to FIG. 3, the present invention further provides a backlight module in which the field emitting light source is incorporated as a light source.

It should be noted that, in this embodiment, a plurality of field emitting light sources 31, 32, 33, 34, 35 and 36 are incorporated. In addition, conductive traces 300, 301 are also incorporated, and the exact amount or numbers of the field emitting light sources depends on the total area to be illuminated or identification rate. Substantially, the field emitting light sources can be arranged in array or can be arranged in random. For example, the central area can be arranged with much dense of the field emitting light sources, while in the border area, the number of the field emitting light sources can be less dense. However, in order to achieve as better displaying effect, such as homogeneousness, then the density of the field emitting light source can be increased. However, there should be a balance between the density as well as homogeneousness of the light so as the later will not be compromised. Accordingly, as long as the final homogeneousness of the light is achieved, then the over number of field emitting light sources can be set.

The present invention further provides a display device which is incorporated with the backlight module, field emitting light sources. The display device has a liquid crystal display panel. It should be noted that in order to achieve a better result, a protective film or enhancing film could be incorporated between the liquid crystal display panel and the backlight module. No limitation shall be imposed herewith.

Referring to FIG. 4, and the present invention further provides a method for making a field emitting light source for use with a liquid crystal display device. The method includes, but not limited to the followings steps.

Step S400, creating a first electrode layer on an internal surface of the first substrate, and further creating a light emitting layer configured with quantum clots material on the first electrode layer which is a first transparent conductive layer.

In step S400, the first electrode layer can be created through physical evaporation deposit (PVD) so as to create the first transparent conductive layer. The first transparent conductive layer can be a layer of indium tin oxide (IDO). Of course, in order to facilitate electricity connection, certain conductive traces (not shown in Figures) have to be arranged and no detailed will be given. Substantially, the light-emitting layer can be arranged over the first substrate by means of printing or sputtering. In the currently embodiment, the light emitting layer includes quantum dots which has excellent conductivity according to the current embodiment, and it can effectively increase the performance of the field emitting light source. On the other hand, the quantum dot has narrowed peak, and with the application of the quantum dots, the light-emitting layer can achieve a broadened colors. On the other hand, with the eclipse of the time, the accumulated electrons can be readily drained or discharged, and the performance of the field emitting light source can be maintained. Substantially, with the adjustment and arrangement of the red, green, blue, and yellow quantum dot, a comparably abundant spectrum of different power distribution can be achieved. Later, with the application of a color filter of the display device, a high-end display certified by NTSC and Adobe can be achieved.

Step S401, a second electrode layer is formed on an internal surface of the second substrate facing the first substrate. The second substrate includes a second transparent conductive layer and an electrically charged electron emitter formed on the second transparent conductive layer. The light-emitting layer is arranged between the first and second substrates.

In step S401, substantially, the electrically charged electron emitter can be deployed onto the second transparent conductive layer by means of printing or sputtering.

In step S402, a contained isolation layer is disposed between the first and second substrates.

In step S403, after the isolation is created, a vacuumed status is created between the first and second substrates by drawing air out of the space therebetween through the orifices defined in the first and second substrate. By this arrangement, a vacuumed space is created between the first and second substrate. The light emitting layer and the electrically charged electron emitter are disposed within the vacuumed space completely or in partial.

In step S403, the packaging process can be performed under 300 to 600 degrees Celsius. Substantially, it can be performed between 400 to 500 degrees Celsius. Since it is typically known to the skill in the art, and no limitation should he imposed. In the current embodiment, the packaging process is undergone between 300 to 600 degrees Celsius, and a field emitting light source with excellent performance of homogeneous and emitting property can be ensured.

Step S404, after a vacuumed condition is achieved, the orifice is sealed accordingly.

It should be noted that the first substrate could be made from ordinary glass, a clear glass, or a super clear glass or any other harder and transparent material. In the current embodiment, a comparably cost-effective clear glass is used which satisfies requirements of lower absorption, and high penetration rate (more than 90%). Of course, in other embodiment, a super clear glass can also be utilized. This super clear glass can be utilized into a high-end field emitting light source. In addition, the thickness of the first substrate 11 ranges 5˜15 micrometer. It can be readily appreciated that the thickness can be readily adjusted according to the requirements of the field emitting light source. No limitation will be imposed herewith.

The second substrate and the first substrate are arranged in face-to-face manner. In the present invention, the internal surfaces or the facing surfaces of the first and second substrates are defined as internal side, and it should be noted that the first and second substrates are arranged in parallel. It should be noted that the first and second substrates could be arranged with a predetermined angle. For example, if a reflector is incorporated within the field emitting light source, then a predetermined angle will be set between the first and second substrates as long as a back light source can be defined. Similarly, the second substrate can be made from ordinary glass, a clear glass, or a super clear glass or any other harder and transparent material. In the current embodiment, a comparably cost-effective clear glass is used which satisfies requirements of lower absorption and high penetration rate (more than 90%). Of course, in other embodiment, a super clear glass can also be utilized. This super clear glass can be utilized into a high-end field emitting light source. In addition, the thickness of the first substrate ranges 5˜15 micrometer. It can be readily appreciated that the thickness can be readily adjusted and increased according to the requirements of the field emitting light source. In the current embodiment, the light can be projected from one side of the first substrate so as to provide the illumination to the liquid crystal display device. Alternatively, the light can be projected from a side from the second substrate with a reflector incorporated thereof. No limitations should be imposed herewith.

The electrically charged electron emitter can be made from nanotubes of carbon or zinc oxide or alternatively, a composition of carbon and zinc oxide nanotubes mixed with a certain ratio. The isolation layer can include glass powder of low melting point.

It should be noted that a diffusing arrangement can be created on the external surfaces of the first and second substrates so as to improve the homogeneousness of the projected light beam emitted therefrom. The substantial configuration can be readily determined according to field requirements, and it can be readily appreciated by the skill in the art. No detailed description will be given herewith.

The other configuration and arrangement of field emitting light source made in accordance with the present invention can be referred to the above described embodiments, and as it can be readily known to the skilled in the art, not detailed description will be given.

According, to the present invention, since the quantum dot material has been incorporated into the field emitting light source as a light-emitting layer, the excellent conductivity of the quantum dot material can readily improve the light emitting capacity as well as broadened colors as compared to the conventional fluorescent powder. In addition, with the time lapses, the accumulated charges or electrons can be effectively discharged or drained out, and the light emitting capacity of high performance can be maintained. In addition, with the application of the field emitting light source, the waveguide, reflector and diffuser can be omitted thereby effectively reduce the manufacturing cost of the backlight module and the display device.

Embodiments of the present invention have been described, but not intending to impose any unduly constraint to the appended claims. Any modification of equivalent structure or equivalent process made according to the disclosure and drawings of the present invention, or any application thereof directly or indirectly, to other related fields of technique, is considered encompassed in the scope of protection defined by the claims of the present invention.

1. A field emitting light source for use with a backlight module, comprising:
first and second substrates arranged relatively with each other and made from glass substrate;
a first electrode layer formed on an internal side of the first substrate and which is a first transparent conductive layer on which a light emitting layer is deployed thereon by means of printing or sputtering;
a second electrode layer formed on an internal side of the second substrate and which includes a second transparent conductive layer and an electrically charged electron emitter formed on the second transparent conductive layer, wherein the electrically charged electron emitter includes nanotubes made from carbon or zinc oxide;
an light emitting layer arranged between the first and second transparent conductive layers, and formed over the first transparent conductive layer, wherein the light emitting layer includes a quantum dot material; and
wherein the second transparent conductive layer is used to emit electrons toward the light-emitting layer so as to create illumination for being used in a backlight module.

2. The field emitting light source as recited in claim 1, wherein the electrically charged electron emitter is deployed over the second conductive layer by means of printing or sputtering.

3. The field emitting light source as recited in claim 1, wherein the field emitting light source further includes two contained isolation layers arranged between the first and second substrates such that a vacuumed space is created between the first and second substrates, wherein the light emitting layer and the electrically charged electron emitter are arranged within the vacuumed space completely or in partial.

4. The field emitting light source as recited in claim 3, wherein the material used to form the contained isolation layers includes glass powder with low melting point.

5. A field emitting light source for use with a backlight module, comprising:
first and second substrates arranged relatively with each other;
a first electrode layer formed on an internal side of the first substrate;
a second electrode layer formed on an internal side of the second substrate;
an light emitting layer arranged between the first and second electrode layers, and formed over the first electrode layer, wherein the light emitting layer includes a quantum dot material; and
wherein the second electrode layer is used to emit electrons toward the light-emitting layer so as to create illumination for being used in a backlight module.

6. The field emitting light source as recited in claim 5, wherein the first electrode layer is a first transparent conductive layer on which a light emitting layer is deployed thereon by means of printing or sputtering.

7. The field emitting light source as recited in claim 5, wherein the first second electrode layer includes a second transparent conductive layer formed on the second substrate and an electrically charged electron emitter formed on the second transparent conductive layer, wherein the electrically charged electron emitter includes nanotubes made from carbon or zinc oxide.

8. The field emitting light source as recited in claim 7, wherein the electrically charged electron emitter is deployed over the second conductive layer by means of printing or sputtering.

9. The field emitting light source as recited in claim 7, wherein the field emitting light source further includes two contained isolation layers arranged between the first and second substrates such that a vacuumed space is created between the first and second substrates, wherein the light emitting layer and the electrically charged electron emitter are arranged within the vacuumed space completely or in partial.

10. The field emitting light source as recited in claim 9, wherein the material used to form the contained isolation layers includes glass powder with low melting point.

11. A display device configured with a backlight module having a field emitting light source, comprising:
first and second substrates arranged relatively with each other;
a first electrode layer formed on an internal side of the first substrate;
a second electrode layer formed on an internal side of the second substrate;
an light emitting layer arranged between the first and second electrode layers, and formed over the first electrode layer, wherein the light emitting layer includes a quantum dot material; and
wherein the second electrode layer is used to emit electrons toward the light-emitting layer so as to create illumination for being used in a backlight module.

12. The display device as recited in claim 11, wherein the first electrode layer is a first transparent conductive layer on which the light emitting layer is deployed thereon by means of printing or sputtering.

13. The display device as recited in claim 11, wherein the second electrode layer includes a second transparent conductive layer formed on the second substrate and an electrically charged electron emitter formed on the second transparent conductive layer, wherein the electrically charged electron emitter includes nanotubes made from carbon or zinc oxide.

14. The display device as recited in claim 13, wherein the electrically charged electron emitter is deployed over the second conductive layer by means of printing or sputtering.

15. The display device as recited in claim 13, wherein the field emitting light source further includes two contained isolation layers arranged between the first and second substrates such that a vacuumed space is created between the first and second substrates, wherein the light emitting layer and the electrically charged electron emitter are arranged within the vacuumed space completely or in partial.

16. The display device as recited in claim 15, wherein the material used to form the contained isolation layers includes glass powder with low melting point.
